(19) United States
(12) Patent Application Publication
(10) Pub. No.: US 2008/0165096 A1
(43) Pub. Date: Jul. 10, 2008

(54) Flat Panel Display

(75) Inventor: Yu-Wen CHIOU, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX TECHNOLOGIES LIMITED, Tainan County (TW)

(21) Appl. No.: 11/621,161

(22) Filed: Jan. 9, 2007

(51) Int. Cl. G09G 3/36

(52) U.S. Cl. 345/87

(57) ABSTRACT

A display has a pixel, a driver, and a switching circuit. The pixel is driven by a signal transmitted on a conducting line. The driver operates in a transient state during transient periods and outputs driving voltages for the pixel during writing periods each following one of the transient periods. The switching circuit couples a reference voltage to the conducting line during the transient periods.

### BACKGROUND

1. Field of Invention

The present invention relates to a flat panel display, and more particularly relates to a flat panel display with an adjustable driving time margin.

2. Description of Related Art

Flat panel displays (FPD) have become very popular due to their advantages of high image quality, compact size, light weight, low driving voltage and low power consumption. They are especially suitable for portable TVs, portable multimedia players, mobile phones, PDAs (personal digital assistants), portable game consoles, and many other kinds of portable consumer electronics including a display.

In the traditional flat panel display, the writing period for image data to be written into the pixels starts from the falling edge of the trigger pulse to the rising edge of the scan pulse. Thereby, the traditional design restricts the driving time margin by the trigger pulse and reduces the efficiency of the pixel operation. Therefore, a flat panel display with an adjustable driving time margin is necessary for the pixel to operate more efficiently.

### SUMMARY

It is therefore an aspect of the present invention to provide a flat panel display.

It is therefore another aspect of the present invention to provide a flat panel display with an adjustable driving time margin.

According to one embodiment of the present invention, the display has a pixel, a driver, and a switching circuit. The pixel is driven by a signal transmitted on a conducting line. The driver operates in a transient state during several transient periods and outputs driving voltages for the pixel during several writing periods each following one of the transient periods. The switching circuit couples a reference voltage to the conducting line during the transient periods.

According to another embodiment of the present invention, the display has a group of pixels, a driving, and a switching circuit. The pixels are sequentially driven by a signal transmitted on a conducting line. The driver operates in a transient state during several transient periods and outputs driving voltages for each of the pixels during several writing periods each following one of the transient periods. The switching circuit couples a reference voltage to the conducting line during the transient periods.

According to another embodiment of the present invention, the display has a group of pixels, a driver, and a switching circuit. The pixels are sequentially driven by a signal transmitted on a conducting line during a scan period. The driver operates in a transient state during several transient periods and outputs a driving voltage for each of the pixels during a writing period following one of the transient periods, wherein the transient and writing periods are within the scan period. The switching circuit couples a reference voltage to the conducting line during a pre-charging period that starts after the start of the scan period and ends before the first one of the writing periods.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows part of a flat panel display according to one embodiment of the present invention;

FIG. 1A shows the timing of the signals used in the display of FIG. 1 according to one embodiment of the invention;

FIG. 1B shows the timing of the signals used in the display of FIG. 1 according to another embodiment of the invention;

FIG. 2 shows part of a flat panel display according to another embodiment of the present invention;

FIG. 2A shows the timing of the signals used in the display of FIG. 2 according to one embodiment of the invention; and

FIG. 2B shows the timing of the signals used in the display of FIG. 2 according to another embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

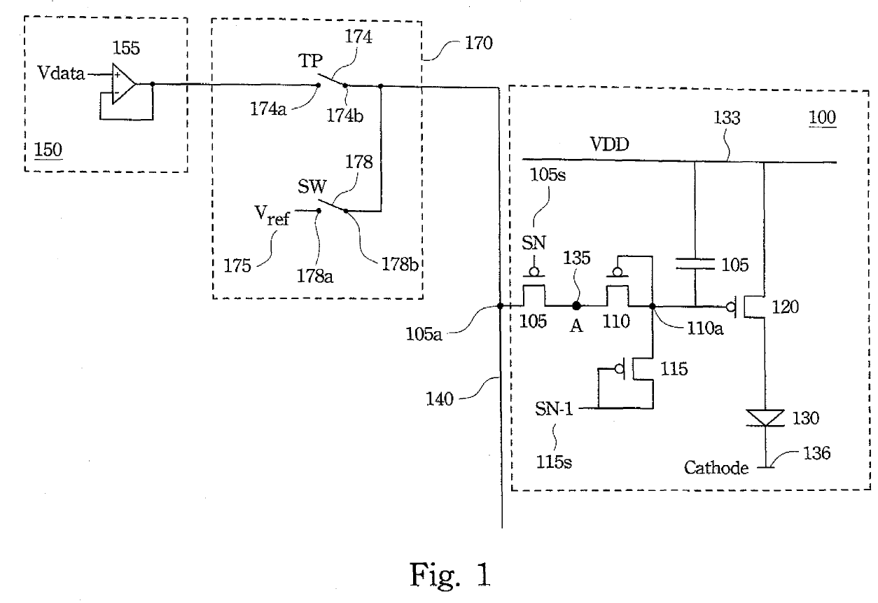

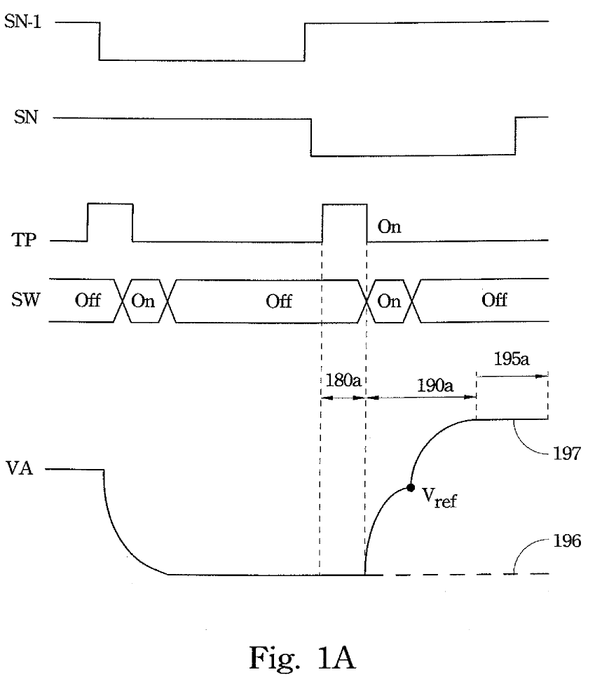

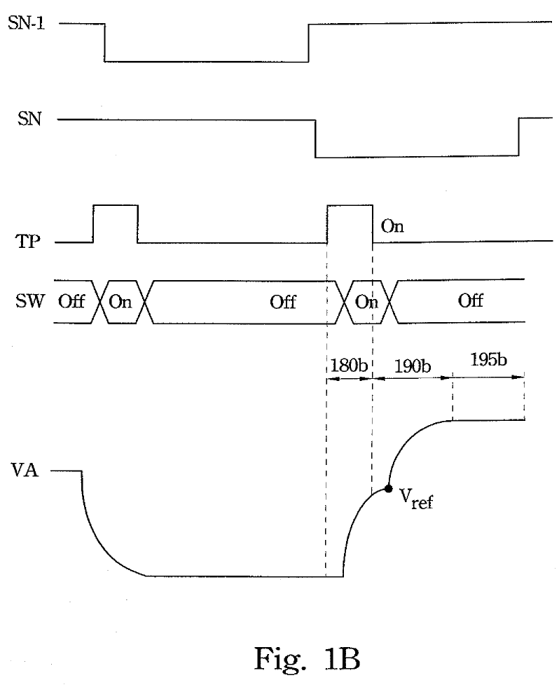

FIG. 1 shows part of a flat panel display according to one embodiment of the present invention. The display has a pixel 100, a driver 150, and a switching circuit 170. The pixel 100 is driven by a signal transmitted on a conducting line 140. The driver 150 operates in a transient state during several transient periods and outputs driving voltages for the pixel 100 during several writing periods each following one of the transient periods. The switching circuit 170 couples a reference voltage 175 to the conducting line during the transient periods.

The switching circuit 170 couples the driving voltages to the conducting line 140 during the writing periods, and the driving voltages is generated by the driver 150.

The switching circuit 170 has a signal switch 174 and a voltage switch 178. The signal switch 174 has one end 174a coupled to receive the driving voltages and the other end 174b coupled to the conducting line 140. The voltage switch 178 has one end 178a coupled to receive the reference voltage and the other end 178b coupled to the conducting line 140. The voltage switch 178 is turned on during the transient periods and the signal switch 174 is turned on during the writing periods.

The voltage switch 178 is turned on during a part of each writing period. When the voltage switch 178 is turned on, the reference voltage 175 is transmitted to the pixel 100 by the conducting line 140. The reference voltage 175 is arranged to charge the pixel 100 so that the driver 150 drives the pixel 100 more easily.

The driver 150 has a buffer device 155 coupled to the signal switch 174. The buffer device 155 is arranged to stabilize the driving voltages transmitted to the pixel 100. The designer can select different buffer devices according to the amount or type of pixels driven by the driver 150.

Take the OLED (Organic Light-Emitting Diode) flat panel display for example; the pixel 100 ordinarily includes several transistors 105, 110, 115, 120, a capacitor 225, and an OLED 130. The transistors 105, 110 and 115 are connected in series, wherein the transistor 105 couples to the conducting line 140 at a node 105a. The gate of the transistor 120 couples to a node 11a between the transistors 110 and 115, and the gate of the transistor 110 couples to the node 110a. The capacitor 225 is coupled between the node 110a and a high voltage end (VDD) 133, and the transistor 120 is coupled between the high voltage end 133 and the OLED 130. Another end of the OLED 130 couples to the cathode 136.

In the pixel circuit, the gate of the transistor 105 is controlled by the signal 105s (SN), and the gate of the transistor 115 is controlled by the signal 115s (SN-1). The signal switch 174 is controlled by a signal TP, and the voltage switch 178 is controlled by a signal SW. The driver 150 generates the signals 105s, 115s, TP, and SW.

FIG. 1A shows the timing of the signals used in the display of FIG. 1 according to one embodiment of the invention. The driver 150 operates in a transient state during the transient period 180a and outputs driving voltages for the pixel 100 during the writing period 190a following the transient period 180a. Here the writing period 190a is after the transient period 180a, and the display period 195a is after the writing period 190a. The switching circuit 170 couples the reference voltage 175 to the conducting line 140 during the transient period 180a.

At the start of the period 180a, the signal 105s (SN) turns on the transistor 105, and the signal 115s (SN-1) turns off the transistor 115. When the signal TP drops, the signal switch 174 is turned on to transmit the driving voltage to the pixel 100. Meanwhile, the signal SW turns the voltage switch 178 on to transmit the reference voltage 175 to the pixel 100 during the transient period 180a so that the voltage VA on the node 135 increases to the reference voltage 175 (Vref). The reference voltage 175 is arranged to charge the pixel 100 to enable the driver 150 drive the pixel 100 more easily.

The reference voltage 175 is within a range from the lowest driving voltage 196 to the highest driving voltage 197 of the driving voltages. The designer can select a reference voltage within the range according to the performance requirement of the driver 150 or the pixel 100.

FIG. 1B shows the timing of the signals used in the display of FIG. 1 according to another embodiment of the invention. The signal SW turns on the voltage switch 178 earlier than that of FIG. 1A does. Thus, before the signal TP turns on the switch 174, the signal SW turns on the voltage switch 178 during the transient period 180b. By this operation, the required writing period 190b is shorter than the writing period 190a of FIG. 1A. Therefore, in the embodiment of FIG. 1B, the display period 195b starts earlier and the driving time margin increases.

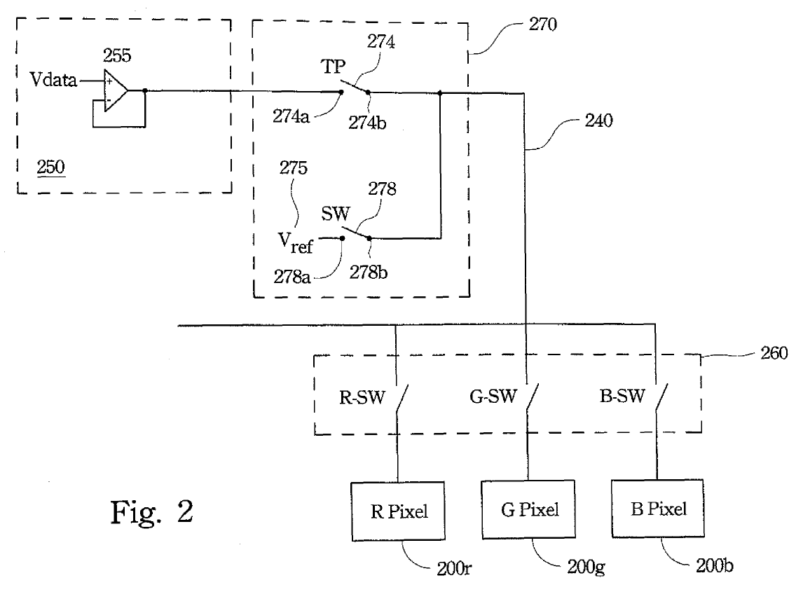

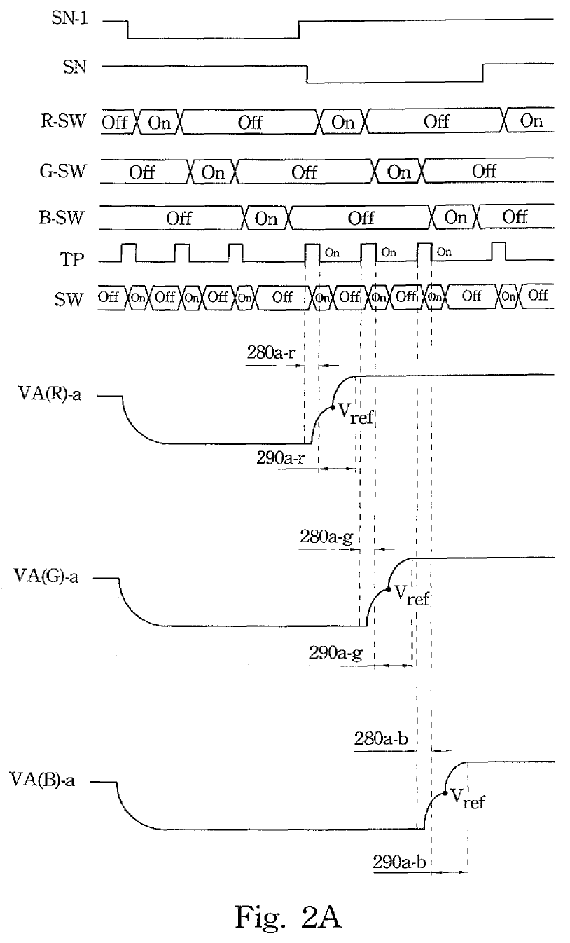

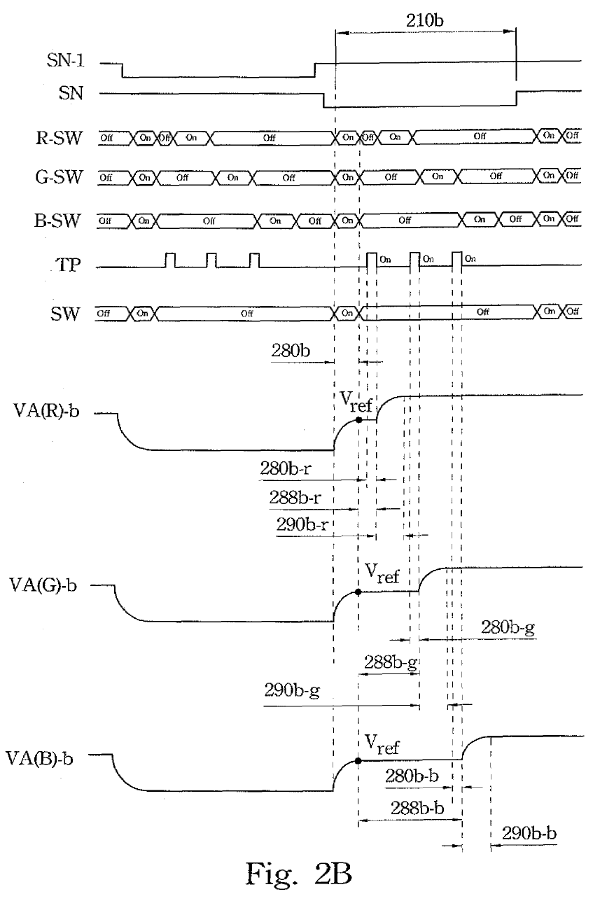

FIG. 2 shows part of a flat panel display according to another embodiment of the present invention. This embodiment here takes three pixels (a red, a green, and a blue pixels) as an example.

The display has a group of pixels 200r, 200g, and 200b, a driver 250, and a switching circuit 270. The pixels 200r, 200g and 200b are sequentially driven by a signal transmitted on a conducting line 240. The driver 250 operates in a transient state during transient periods and outputs driving voltages for each of the pixels 200r, 200g, and 200b during the writing periods each following one of the transient periods. The switching circuit 270 couples a reference voltage 275 to the conducting line 240 during the transient periods.

The switching circuit 270 has a signal switch 274 and a voltage switch 278. The signal switch 274 has one end 274a coupled to receive the driving voltages and the other end 274b coupled to the conducting line 240. The voltage switch 278 has one end 278a coupled to receive the reference voltage and the other end 278b coupled to the conducting line 240. The selector 260 sequentially couples the pixels 200r, 200g, and 200b to the conducting line 240. Each of the pixels 200r, 200g, and 200b is coupled to the conducting line 240 during one of the writing periods, the voltage switch 278 is turned on during the transient periods and the signal switch 274 is turned on during the writing periods.

The switches R-SW, G-SW and B-SW of the selector 260 are arranged to respectively connect the pixels 200r, 200g, and 200b to the conducting line 240. The operation of the pixel is described below.

FIG. 2A shows the timing of the signals used in the display of FIG. 2 according to one embodiment of the invention. Each of the pixels 200r, 200g and 200b is the same as the pixel 100 of FIG. 1. Therefore, the signals SN-1, SN, TP and SW correspond to the same signals shown in FIG. 1. The signals R-SW, G-SW and B-SW are used to control the R-SW, G-SW and B-SW switches respectively. The VA(R)-a, VA(G)-a and VA(B)-a are respectively the voltages of points inside the pixels 200r, 200g and 200b corresponding to the node A of the pixel 100 of FIG. 1.

The driver 250 operates in a transient state during several transient periods 280a-r, 280a-g and 280a-b, and sequentially outputs driving voltages for the pixel 200r, 200g and 200b during writing periods 290a-r, 290a-g, and 290a-b respectively following the transient periods 280a-r, 280a-g, and 280a-b. The switching circuit 270 sequentially couples the reference voltage 275 to the conducting line 240 during the transient periods 280a-r, 280a-g, and 280a-b by the signal SW.

At the start of the transient period 280a-r, the signal SN and SN-1 turns on and off the corresponding transistors in the pixels 200r, 200g and 200b. When the signal TP falls down, the signal switch 274 is turned on to transmit the driving voltages to the conducting line 240; and when the signal SW turns the voltage switch 278 on, the reference voltage 275 is transmitted to the conducting line 240. In order to pre-charge and write the data into the pixels 200r, 200g and 200b sequentially, the signals R-SW, G-SW and B-SW sequentially turns the switches R-SW, G-SW and B-SW on. Therefore, the driver 250 can sequentially pre-charge the pixels 200r, 200g and 200b with the reference voltage 275, and sequentially write the data into the pixels 200r, 200g and 200b by the driving voltages.

FIG. 2B shows the timing of the signals used in the display of FIG. 2 according to another embodiment of the invention. The display has a group of pixels 200r, 200g, 200b, a driver 250, and a switching circuit 270. The pixels 200r, 200g and 200b are sequentially driven by a signal transmitted on a conducting line 240 during a scan period 210b. The driver 250 operates in a transient state during several transient periods 280b-r, 280b-g and 280b-b, and outputs a driving voltage for each of the pixels 200r, 200g and 200b during a writing period following one of the transient periods (such as the writing period 290b-r follows the transient period 280b-r), wherein the transient periods 280b-r, 280b-g and 280b-b, and the writing periods 290b-r, 290b-g and 290b-b are within the scan period 210b. The switching circuit 270 couples a reference voltage to the conducting line 240 during a pre-charging period 280b that starts after the start of the scan period 210b and ends before the first one of the writing periods (i.e. 290b-r).

The switching circuit 270 has a signal switch 274 and a voltage switch 278 shown in FIG. 2. The selector 260 couples all the pixels 200r, 200g, and 200b to the conducting line 240 during the pre-charging period 280b and sequentially couples the pixels 200r, 200g, and 200b to the conducting line 240 during the rest of the scan period 210b. Each of the pixels 200r, 200g, and 200b is sequentially coupled to the conducting line 240 during one of the writing periods 290b-r, 290b-g, and 290b-b, the voltage switch 278 is turned on during the pre-charging period 280b and the signal switch is turned on during the writing periods 290b-r, 290b-g, and 290b-b.

The signals SW, R-SW, G-SW and B-SW simultaneously turn on the voltage switch 278, the switches R-SW, G-SW, and B-SW during the pre-charging period 280b. Thus, the level of the voltage VA(R)-b, VA(G)-b and VA(B)-b is maintained at V_{ref} respectively during the periods 288b-r, 288b-g, and 288b-b. In other words, the periods 288b-r, 288b-g, and 288b-b are after the pre-charging period 280b, and before the writing periods 290b-r, 290b-g, 290b-b respectively. Therefore, the driver 250 can pre-charge the pixels 200r, 200g and 200b with the reference voltage 275 simultaneously, and write the data into the pixels 200r, 200g and 200b by the driving voltages sequentially.

It is noted that the difference between FIG. 2A and FIG. 2B is that the waveform of FIG. 2B has the periods 288b-r, 288b-g, and 288b-b. These periods 288b-r, 288b-g, and 288b-b lower the operation frequency of the voltage switch 278 (controlled by the signal SW) so that the power consumption and noise is reduced.

Therefore, in the previously described embodiments, the driving time margin is adjustable by the control of the voltage switch (controlled by the signal SW). Moreover, the amount of the voltage switch and the routing line are reduced by using a selector cooperated with the switching circuit and several pixels. Thus, the aperture ratio of the flat panel display is also improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display comprising:
a pixel driven by a signal transmitted on a conducting line;
a driver operating in a transient state during a plurality of transient periods and outputting driving voltages for the pixel during a plurality of writing periods each following one of the transient periods; and
a switching circuit coupling a reference voltage to the conducting line during the transient periods.

2. The display as claimed in claim 1, wherein the switching circuit couples the driving voltages to the conducting line during the writing periods.

3. The display as claimed in claim 2, wherein the switching circuit comprises:
a signal switch having one end coupled to receive the driving voltages and the other end coupled to the conducting line; and
a voltage switch having one end coupled to receive the reference voltage and the other end coupled to the conducting line;
wherein the voltage switch is turned on during the transient periods and the signal switch is turned on during the writing periods.

4. The display as claimed in claim 3, wherein the voltage switch is turned on during part of each writing period.

5. The display as claimed in claim 1, wherein the driver comprises a buffer device coupled to the signal switch.

6. The display as claimed in claim 1, wherein the reference voltage is within a range from the lowest to highest one of the driving voltages.

7. A display comprising:
a group of pixels sequentially driven by a signal transmitted on a conducting line;
a driver operating in a transient state during a plurality of transient periods and outputting driving voltages for each of the pixels during a plurality of writing periods each following one of the transient periods; and
a switching circuit coupling a reference voltage to the conducting line during the transient periods.

8. The display as claimed in claim 7, wherein the switching circuit couples the driving voltages to the conducting line during the writing periods.

9. The display as claimed in claim 8, wherein the switching circuit comprises:
a signal switch having one end coupled to receive the driving voltages and the other end coupled to the conducting line;
a voltage switch having one end coupled to receive the reference voltage and the other end coupled to the conducting line; and
a selector sequentially coupling the pixels to the conducting line;
wherein each of the pixels is coupled to the conducting line during one of the writing periods, the voltage switch is turned on during the transient periods and the signal switch is turned on during the writing periods.

10. The display as claimed in claim 9, wherein the voltage switch is turned on during each part of each writing period.

11. The display as claimed in claim 7, wherein the driver comprises a buffer device coupled to the signal switch.

12. The display as claimed in claim 7, wherein the reference voltage is within a range from the lowest to highest one of the driving voltages.

13. The display as claimed in claim 7, wherein the group of pixels comprises pixels for red, green and blue.

14. A display comprising:
a group of pixels sequentially driven by a signal transmitted on a conducting line during a scan period;
a driver operating in a transient state during a plurality of transient periods and outputting a driving voltage for each of the pixels during a writing period following one of the transient periods, wherein the transient and writing periods are within the scan period; and
a switching circuit coupling a reference voltage to the conducting line during a pre-charging period that starts after the start of the scan period and ends before the first one of the writing periods.

15. The display as claimed in claim 14, wherein the switching circuit couples the driving voltages to the conducting line during the writing periods.

16. The display as claimed in claim 15, wherein the switching circuit comprises:
a signal switch having one end coupled to receive the driving voltages and the other end coupled to the conducting line;
a voltage switch having one end coupled to receive the reference voltage and the other end coupled to the conducting line; and
a selector coupling all the pixels to the conducting line during the pre-charging period and sequentially coupling the pixels to the conducting line during the rest of the scan period;
wherein each of the pixels is coupled to the conducting line during one of the writing periods, the voltage switch is turned on during the transient periods and the signal switch is turned on during the writing periods.

17. The display as claimed in claim 16, wherein the voltage switch is turned on during part of each writing period.

18. The display as claimed in claim 14, wherein the driver comprises a buffer device coupled to the signal switch.

19. The display as claimed in claim 14, wherein the reference voltage is within a range from the lowest to highest one of the driving voltages.

20. The display as claimed in claim 14, wherein the group of pixels comprises pixels for red, green and blue.
